(19) United States
(12) Patent Application Publication
(10) Pub. No.: US 2018/0165759 A1
(43) Pub. Date: Jun. 14, 2018

(54) Systems and Methods for Identifying Card-on-File Payment Account Transactions

(71) Applicant: MASTERCARD INTERNATIONAL INCORPORATED, Purchase, NY (US)

(72) Inventors: James Ernest Carrington, Greenwich, CT (US); Stephen Dantu, Armonk, NY (US); Matthew Sordi, Sandy Hook, CT (US); Divyam Mayawala, Scarsdale, NY (US); Harry Chen, Port Chester, NY (US)

(21) Appl. No.: 15/375,838

(22) Filed: Dec. 12, 2016

(51) Int. Cl. G06Q 40/02; G06Q 20/36; G06Q 20/10

(52) U.S. Cl. CPC G06Q 40/02; G06Q 20/102; G06Q 20/36

(57) ABSTRACT

Systems and methods are provided for use in identifying card-on-file payment account transactions. An example method includes accessing, by a computing device, transaction data included in a data structure, where the transaction data includes transaction data for a transaction associated with a payment account and involving a merchant. The method also includes generating, by the computing device, a card-on-file probability score for the transaction, based on whether the transaction data includes a recurring payment indicator for the transaction, whether the transaction involves a known card-on-file application, whether the merchant is a known card-on-file merchant, whether a card verification code is included in the transaction data for the transaction, and/or whether other transactions to the payment account and involving the merchant have been made in a defined interval. In connection therewith, a card-on-file status of the transaction is true when the card-on-file probability score satisfies a defined threshold.

### FIELD

The present disclosure generally relates to systems and methods for use in identifying card-on-file payment account transactions.

### BACKGROUND

This section provides background information related to the present disclosure which is not necessarily prior art.

Payment accounts are used by consumers to perform numerous different transactions including, for example, purchasing products (e.g., goods and/or services) from merchants, etc. Transaction data is often generated in connection with the transactions and stored in/by payment networks and/or parties associated with the payment networks (e.g., issuers, acquires, etc.). The transaction data includes a variety of different types of data related to the transactions, including, for example, merchant IDs, acquirer IDs, merchant category codes (MCCs), transaction amounts, etc. The transaction data is known to be analyzed to provide models, for example, for use in combating fraud, identifying likely purchasers for advertising and/or incentives, etc. While different data is relied upon in providing the various services, accuracy of the transaction data is indicative of accuracy of any models derived therefrom.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in identifying transactions as card-on-file transactions;

FIG. 2 is a block diagram of an exemplary computing device that may be used in the system of FIG. 1; and

FIG. 3 is an exemplary method, which may be implemented in the system of FIG. 1, for use in identifying a transaction as a card-on-file transaction.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Transaction data is often compiled by payment networks, for example, in connection with payment device transactions by consumers at merchants. The transaction data may then be used, by the payment networks, in connection with providing a variety of services (e.g., advertising services, anti-fraud services, other services, etc.), etc. For the transaction data to be useful, in some instances, the transaction data may be augmented to include additional data, which is captured from other sources and/or derived from the transaction data. Uniquely, the systems and methods herein facilitate generation of card-on-file predictions for transactions, and then append the predictions to the transaction data, whereby various services provided by the payment networks (or others) are permitted to rely on the card-on-file predictions. In particular, for a transaction, a prediction engine, in at least one embodiment, is able to generate a card-on-file probability score for a particular market and/or category, based on factors such as, for example, whether the transaction is a recurring transaction, involves a consumer-type application, is directed to a known card-on-file merchant, or includes a card verification code (CVC). In addition, the prediction engine may also rely on prior purchase history of the payment account to which the transaction is directed, as part of generating the probability score. Then, the card-on-file probability score is compared to a defined threshold to determine whether or not the transaction is a card-on-file transaction (whereupon the transaction is tagged/labeled accordingly). As such, through the systems and methods herein, in connection with processing transaction data for the transaction (and other transactions) in providing the variety of services, another data point is yet included to direct and/or enhance the services as appropriate, etc.

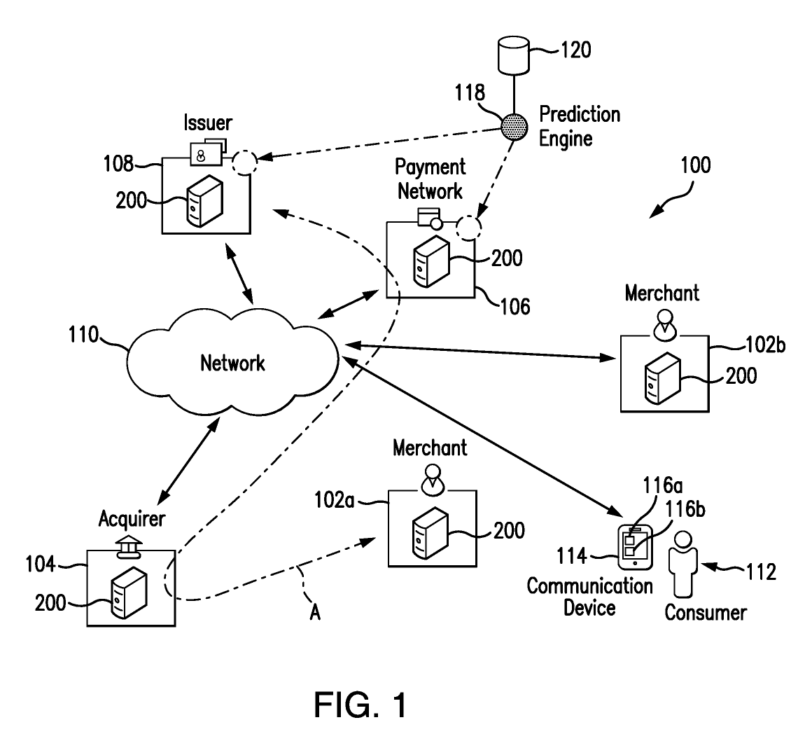

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise depending on, for example, processing of payment account transactions, manners in which transaction data is utilized and/or improved or modified, etc.

As shown in FIG. 1, the illustrated system 100 generally includes merchants 102a-b associated with providing products to consumers, an acquirer 104 associated with the merchants 102a-b, a payment network 106, and an issuer 108 associated with payment accounts used by consumers to perform transactions at the merchants 102a-b. Each of the merchants 102a-b, the acquirer 104, the payment network 106, and the issuer 108 is coupled to (and is in communication with) network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In particular in this example, the acquirer 104, the payment network 106, and the issuer 108 may be connected via a private payment transaction network that is part of network 110 for processing payment account transactions, and the merchants 102a-b may be connected with consumers for effecting payment account transactions, for example, through a public network, such as the Internet, that is also part of network 110.

In the system 100, the merchants 102a-b offer products for sale to consumers, including consumer 112. In this exemplary embodiment, the merchants 102a-b represent multiple different merchants, and specifically, different types of merchants. For example, the merchant 102a may be a telecom service provider, while the merchant 102b may be a ride-share service provider (e.g., Uber® car service, etc.). It should be appreciated, however, that any number and/or type of merchants may be included in systems in other embodiments, and that the specific types and numbers of merchants described herein are merely exemplary. For example, in various other embodiments, the system 100 may include one or more merchants configured to provide products relating to digital goods (e.g., videos, movies, music, etc.) and/or utilities (e.g., gas, electric, water, etc.), and/or one or more merchants related to online retail. Further, the merchants 102a-b in the system 100 (and/or other merchants potentially included in the system 100) may include one or more locations for offering such products to consumers including, for example, brick-and-mortar locations and/or virtual locations (e.g., websites, etc.).

The consumer 112, which interacts with the merchants 102a-b to purchase the products therefrom, is associated with a payment account issued by the issuer 108. Through the payment account, the consumer 112 can fund such purchases for the products, via payment account transactions.

The consumer 112 is also associated with a communication device 114. The communication device 114, in this exemplary embodiment, includes two applications: a virtual wallet application 116a and an application 116b specific to the merchant 102b. The virtual wallet application 116a may include, for example, PayPass® from MasterCard, Apple Pay® from Apple, PayWave® from VISA, SamsungPay® from Samsung, etc., or other virtual wallet-type applications. Additionally, the application 116b specific to the merchant 102b may include any variety of applications, which permits the consumer 112 to facilitate payment account transactions with the merchant 102b, or so-called in-application transactions. One example application is the Uber® car service application, through which a consumer is able to purchase ride services, and pay through the application. In any case, the two applications 116a-b at the consumer's communication device 114 generally permit the consumer 112 to register for an account with the applications 116a-b and store payment account information for his/her payment account as part of the registered account, to facilitate efficient and/or convenient transactions there through with the merchants 102a-b (with the merchant-specific application 116b typically being limited to use with the merchant 102b, for example). In this manner, the applications 116a-b may provide for one or more card-on-file transactions.

As described above, the merchants 102a-b may offer virtual merchant storefronts, such as, for example, websites, which are not installed and/or are not specific to the communication device 114. Like the applications 116a-b, however, the websites, for example, may permit the consumer 112 to register for an account and further to store payment account information as part of the account, to facilitate efficient and/or convenient transactions there through. In this manner, the virtual merchant storefronts further may provide one or more card-on-file transactions for the consumer 112 (and other consumers). As also described above, the merchants 102a-b may include brick-and-mortar locations, at which the consumer 112 may store payment account information for his/her payment account so that the consumer 112 need repeatedly present his/her account credentials to the merchant for each transaction. As such, the merchants 102a-b may provide one or more card-on-file transactions for the consumer 112 (and other consumers).

In an exemplary transaction in the system 100, the consumer 112 may seek to purchase a product from the merchant 102a, as one of multiple recurring transactions with the merchant 102a, for example, using his/her payment account (issued by the issuer 108) to fund the purchase (be it at a virtual location of the merchant 102a or a brick-and-mortar location). As such, the consumer 112 may present a payment device (e.g., a credit card, debit card, prepaid card, fob, the communication device 114 with the virtual wallet application 116a active, etc.) to the merchant 102a, or the consumer 112 may direct the merchant 102a to his/her account (e.g., by providing credentials for the account to the merchant 102a, etc.). In either case, the transaction may be initiated by the consumer 112 (e.g., where the consumer 112 initiates each one of the recurring transactions, etc.), or the transaction may be initiated by the merchant 102a based on prior agreement of the consumer 112 (and where the credentials for the consumer's payment account are stored on file with the merchant 102a or, potentially, otherwise stored in one of the applications 116a-b, for example, for presenting to the merchant 102a). More specifically, in the latter, the consumer 112 may pre-arrange payment account transactions with the merchant 102a for the product at one or more regular or irregular intervals. For example, the consumer 112 may permit the merchant 102a to charge a monthly bill to the consumer's payment account, as needed (as a recurring transaction). With that said, it should be appreciated that various types of recurring transactions, to a variety of different types of merchants are possible within the scope of the present disclosure.

Regardless of how the above transaction is initiated, the merchant 102a receives and/or retrieves the credentials for the consumer's payment account and communicates an authorization request (broadly, a transaction message) through the network 110 (along path A in FIG. 1) to the acquirer 104 who, in turn, communicates the request with the issuer 108 through the payment network 106 (again via the network 110), for authorization of the transaction. The authorization request generated by the merchant 102a generally includes an account number (for the consumer's payment account) and an amount of the purchase, and may further include a merchant category code (MCC) for the merchant 102a, a card verification code (CVC) for the consumer's payment account, a terminal ID for a point-of-sale device used in the transaction, an application indicator (application ID) (if the transaction is initiated via one of the applications 116a-b at the consumer's communication device 114), a recurring payment indicator, information regard a payment facilitator when used (e.g., information regarding PayPal®, Alipay™, Square™, etc.), information regarding the virtual wallet application 116a when used, etc.

Upon receiving the authorization request, the issuer 108 determines if the consumer's payment account is in good standing and if there is/are sufficient credit/funds to complete the transaction. If the issuer 108 accepts the transaction, an authorization reply (broadly, a transaction message) is provided back to the merchant 102a (again, generally along path A) and the merchant 102a completes the transaction. The credit line or funds of the consumer, depending on the type of payment account, is then decreased by the amount of the purchase, and the charge is posted to the consumer's payment account. The transaction is later cleared and settled by and between the merchant 102a and the acquirer 104 and by and between the acquirer 104 and the issuer 108 (in accordance with settlement arrangements and via appropriate transaction messages, etc.). Conversely, if the issuer 108 declines the transaction, an authorization reply is provided back to the merchant 102a and the merchant 102a is able to terminate the transaction with the consumer, or request an alternate form of funding.

While described with reference to the merchant 102a, it should be appreciated that transactions between the consumer 112 and merchant 102b (or between other consumers and the merchants 102a-b), and funded by the payment account associated with the consumer 112 (or other payment accounts), will be substantially consistent with the example transaction described above (and may include the same or different acquirers, payment networks, and/or issuers, etc.), depending on the payment account, the consumer, and/or the particular ones of the merchants 102a-b involved, for example.

Transaction data is generated, collected, and stored as part of the above interactions among the merchant 102a (and for similar transactions involving the other merchant 102b), the acquirer 104, the payment network 106, the issuer 108, and the consumer 112. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the acquirer 104 and/or the issuer 108 may store the transaction data, or part thereof, in a data structure. With that said, transaction data may include, for example, payment account numbers, amounts of transactions, CVCs, expiration dates, merchant IDs, terminal IDs, MCCs, merchant names, dates/times of transactions, products purchased and related descriptions or identifiers, etc. In addition, when a recurring payment transaction is directed to the payment account, a recurring payment indicator is included in the transaction data, as available. Further, when the transaction involves the virtual wallet application 116a and/or is facilitated through another application (e.g., application 116b, etc.), an application ID is included in the transaction data particular to the application.

It should be appreciated that more or less information related to transactions, as part of either authorization and/or clearing and/or settling, may be included in transaction data and stored within the system 100. Further, in connection with the payment account, the consumer 112 (and other consumers in the system 100), as involved in the different interactions herein, may be prompted to agree to legal terms associated with his/her payment account and/or associated with the various applications 116a-b included at his/her communication device 114, for example, during enrollment, installation, etc. In so doing, the consumer 112 may voluntarily agree, for example, to allow the issuer 108 of his/her payment account, the payment network 106, and/or the merchants 102a-b, etc., to use data collected during enrollment for the payment account, during installation of the applications 116a-b, and/or in connection with processing transactions associated therewith, subsequently for one or more of the different purposes described herein.

As an example, and for purposes of illustration, Table 1 identifies transaction data for four recent exemplary transactions to the consumer's payment account involving the merchants 102a-b (as may be included in authorization requests for the transactions, etc.). In addition to the four transactions in Table 1, the consumer's payment account was also used in the last year to fund eleven transactions involving the merchant 102a, each in amount ranging from $72.12 to $79.34, and four transactions involving the merchant 102b. It should be appreciated that the transaction data included in Table 1, and the associated transactions, are merely exemplary in nature and are provided for purposes of illustration (and, thus, are not limiting of the scope of the present disclosure).

TABLE 1

| | Transaction #1 | Transaction #2 | Transaction #3 | Transaction #4 |
|---|---|---|---|---|
| Merchant | Merchant 102a | Merchant 102a | Merchant 102b | Merchant 102b |
| Application ID | unknown | 123123123 | 526795311 | Unknown |
| CVC | Yes | No | No | No |
| Recurring payment | Yes | No | No | No |
| indicator | | | | |
| Amount | $75.65 | $13.14 | $14.74 | $121.04 |

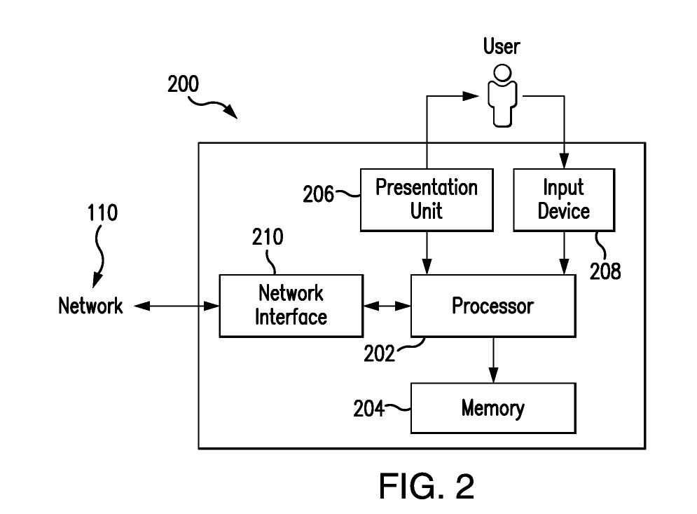

FIG. 2 illustrates an exemplary computing device 200 that can be used in the system 100. The computing device 200 may include, for example, one or more servers, workstations, personal computers, laptops, tablets, smartphones, POS terminals, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In the system 100, each of the merchants 102a-b, the acquirer 104, the payment network 106, and the issuer 108 are illustrated as including, or being implemented in, computing device 200, coupled to the network 110. In addition, the communication device 114 associated with the consumer 112 may be considered a computing device consistent with the computing device 200. However, the system 100 should not be considered to be limited to the computing device 200, as described below, as different computing devices and/or arrangements of computing devices may be used.

Referring to FIG. 2, the exemplary computing device 200 generally includes a processor 202 and a memory 204 coupled to (and in communication with) the processor 202. The processor 202 may include one or more processing units (e.g., in a multi-core configuration, etc.) including, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are exemplary only, and are not intended to limit in any way the definition and/or meaning of processor.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204, and/or data structures included therein, may be configured to store, without limitation, transaction data, card-on-file tags, known card-on-file merchants, known card-on-file applications, CVC penetration data, and/or other types of data and/or information suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

The computing device 200 also includes a presentation unit 206 (or output device or display device) that is coupled to (and is in communication with) the processor 202 (however, it should be appreciated that the computing device 200 could include output devices other than the presentation unit 206, etc.). The presentation unit 206 outputs information, either visually or audibly to a user of the computing device 200, for example, a user associated with the payment network 106 in the system 100 or the issuer 108, individuals associated with other parts of the system 100, the consumer 112, etc. It should be further appreciated that various interfaces may be displayed at computing device 200, and in particular at presentation unit 206, to display information, such as, for example, card-on-file tags, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices.

The computing device 200 further includes an input device 208 that receives inputs from the user of the computing device 200 (i.e., user inputs) such as, for example, initiating a virtual wallet payment, or an in-application payment account transaction, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. In various exemplary embodiments, a touch screen, such as that included in a tablet, a smartphone, or similar device, behaves as both a presentation unit 206 and an input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

With reference again to FIG. 1, the system 100 includes a prediction engine 118, and a data structure 120 coupled to the prediction engine 118 (e.g., accessible by the prediction engine 118, incorporated in and/or stored in memory 204 associated with the prediction engine 118 and/or another computing device 200, etc.). The prediction engine 118 is illustrated as a standalone device (and, for example, is consistent with computing device 200, etc.). Nonetheless, as indicated by the dotted lines, the prediction engine 118 (and/or the data structure 120 (in whole or in part)) may be incorporated into the payment network 106 and/or the issuer 108 (e.g., as part of the corresponding computing device 200 therein, etc.), or further, into other parts of the system 100 illustrated or not in FIG. 1.

While the data structure 120 is illustrated in the system 100 as a single data structure, it should be appreciated that the data structure may include one or multiple different data structures. For example, in the illustrated embodiment, the data structure 120 includes a known application data structure, a known merchant data structure, a CVC data structure, and a historical data structure. However, the data structure 120 may include more or less (or different) data structures in other embodiments. Further, the data structure 120 may be included at a single location, or geographically dispersed over a geographic region. More specifically, the known merchant data structure may be located in one data center, while the historical data structure may be located at a different data center. As used herein, however, each should be understood to be part of the data structure 120, regardless of its physical location.

In connection with the data structure 120, the known application data structure includes a listing of applications that are known to be virtual wallet applications and/or that permit in-application purchases, etc. as part of card-on-file transactions. In connection therewith, the applications may be listed in the data structure 120, for example, by application ID, etc. And, when such an application ID (or other indicator of the application used in a transaction) is included in the authorization request for the transaction, for example, the information can be used as described herein in connection with identifying the transaction as a card-on-file transaction, or not. The known merchant data structure includes a listing of merchants, by merchant ID and/or merchant name, for example, that are known to provide card-on-file payments. The CVC data structure includes data related to penetration of CVC indicators. In particular, certain industries, markets and/or categories of merchants may include a higher incident of CVCs being included in transaction data, than others. The penetration data included in the data structure 120 indicates, for a certain industry, market and/or category, the penetration of CVCs, thereby indicating when a CVC should be expected to be included in transaction data or not. And, the historical data structure contains historical transaction data for consumers, including the consumer 112. For example, the data identified in Table 1 may be included in the historical data structure, along with the other transactions to the consumer's payment account.

The prediction engine 118 of the system 100 is generally configured to determine whether a transaction is a card-on-file transaction, or not. In connection therewith, the prediction engine 118 is configured to access a transaction (e.g., involving the merchant 102a and the consumer 112, etc.) and to determine one or more sub-scores for the transaction. The one or more sub-scores are based on, for example, whether the transaction data associated with the transaction includes a recurring payment indicator for the transaction, whether the transaction involves an application included in the known application data structure, whether the merchant 102a is included in the known merchant data structure, whether a card verification code (CVC) is included in the transaction data for the transaction relative to the CVC penetration data in the CVC data structure, and whether other transactions to the consumer's payment account involving the merchant 102a in a defined interval exist. The prediction engine 118 is also configured to combine the one or more sub-scores into a card-on-file probability score, such as, for example, by summing, averaging, or otherwise subjecting the sub-scores to one or more mathematical operations.

Further, the prediction engine 118 is configured to compare the card-on-file probability score to one or more defined thresholds. When the probability score satisfies the threshold(s) (e.g., is greater than or equal to a defined threshold, etc.), the prediction engine 118 is configured to append a card-on-file tag (or label) to the transaction (and, potentially, to the authorization request for the transaction). Conversely, when the probability score fails to satisfy the threshold(s) (e.g., falls below a defined threshold, etc.), the prediction engine 118 is configured to end the analysis of the transaction and/or to append a tag (or label) to the transaction indicating that it is not a card-on-file transaction. The tag, when present, may then be used in real time (or near-real time) in handling the authorization for the transaction, or after the transaction has occurred to further analyze and/or provide insight to one or more various services potentially associated with the transaction (e.g., anti-fraud services, marketing services, coupon services, etc.).

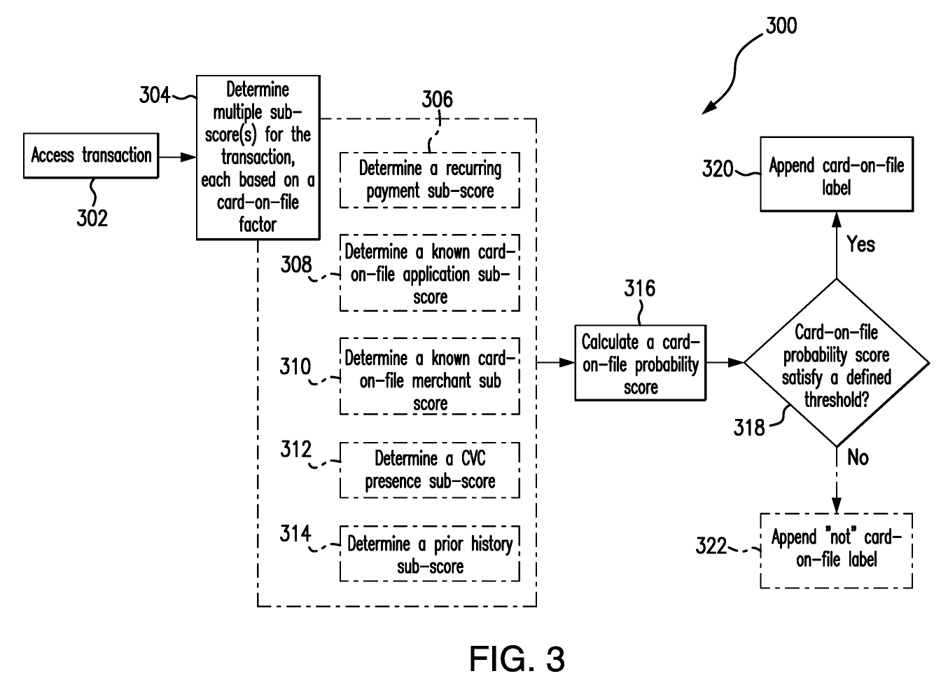

FIG. 3 illustrates an exemplary method 300 for identifying transactions as card-on-file transactions. The exemplary method 300 is described as implemented in the system 100 and, more particularly, in the prediction engine 118 thereof. In addition, the method 300 is described with reference to the computing device 200. Nonetheless, as should be understood, the methods herein (including the method 300) are not limited to the exemplary system 100 or the exemplary computing device 200 and, similarly, the systems and the computing devices herein are not limited to the exemplary method 300. Further, for purposes of illustration, the method 300 is described with reference to the exemplary transactions presented in Table 1. Again, however, the methods herein are not limited to the transactions (or the associated transaction data) included in Table 1, or for that matter, to any particular like or different data.

In the illustrated embodiment, the prediction engine 118 initially accesses, at 302, a transaction to a payment account (e.g., a transaction to the payment account associated with the consumer 112 in the following description). Such access may be based on a particular indicator or other information included in the transaction data for the transaction. Or, the prediction engine 118 may access all transactions associated with one or more of the payment network 106, the issuer 108, one or both of the merchants 102a-b, the acquirer 104, etc.

In connection therewith, the prediction engine 118 may operate in real time (or near-real time), or at some time after the transaction has occurred (and has potentially been cleared and settled), to access the transaction. In the former, the prediction engine 118 may intercept the transaction, in the form of an authorization request, from the acquirer 104, for example, along path A in the system 100 (depending on the location of the prediction engine 118 in the system 100). Then, the authorization request may be impeded from further proceeding while the method 300 (as described herein) is performed, with a result of the method 300, if any, appended to the authorization request for use by one or more parts of the system 100 (or other parts not illustrated in the system 100) as an input for various services provided thereby (e.g., as an input to a fraud model provided by the payment network 106 and/or the issuer 108, etc.). Or, the authorization request may be permitted to proceed in parallel with the method 300 with a result of the method 300, if any, subsequently associated with the transaction and provided to one or more relevant parts of the system 100 (or other parts not illustrated in the system 100), as an input for various services provided thereby (e.g., as an input to an advertising model provided by the payment network 106 and/or the issuer 108, as part of an authorization reply generated by the issuer 108 and/or modified by the payment network 106, or otherwise, etc.). When the transaction is accessed at some later time, however, the prediction engine 118 may access the transaction from any accessible data structure (e.g., in memory 204 at the payment network 106, etc.), whereby sufficient transaction data, as described below, is included for the transaction, and then associate a result of the method 300, if any, with the transaction.

In any case, once the transaction is accessed, the prediction engine 118 determines, at 304, multiple sub-scores for the transaction, where each sub-score is based on at least one card-on-file factor/indicator. As described herein, such card-on-file factors may include, for example, whether the transaction is a recurring transaction, whether the transaction involves a consumer-type application, whether the transaction is directed to a known card-on-file merchant, whether the transition includes a card verification code (CVC), historical transaction data for the associated payment account, etc.

In particular in the illustrated method 300, the prediction engine 118 optionally determines, as indicated by the dotted lines in FIG. 3, five different sub-scores. For example, at 306, the prediction engine 118 determines a recurring payment sub-score for the transaction. To do so, the prediction engine 118 identifies, in the transaction data associated with the transaction, whether a recurring payment indicator is included. If such an indicator is present, the prediction engine 118 assigns a recurring payment sub-score to the transaction, for example, of “1.” If such an indicator is not present, the prediction engine 118 instead assigns a recurring payment sub-score to the transaction, for example, of “0.” As such, with reference to the four transactions in Table 1, the prediction engine 118 may determine the recurring payment sub-score of transaction #1 to be “1,” and the recurring payment sub-score of transactions #2-#4 to be “0.” With that said, it should be appreciated that, in other embodiments, various different recurring payment sub-scores may be assigned by the prediction engine 118, or more broadly determined (other than simply “0” and “1”), based the presence or absence of the recurring payment indicator.

At 308, the prediction engine 118 determines a known card-on-file application sub-score for the transaction, which is based on the data structure 120 and, in particular, on the known application data structure thereof. Here, the known application data structure includes a listing of two types of applications: virtual wallet applications and applications that support in-application transactions. The prediction engine 118 identifies the associated application based on an ID associated therewith, for example, an application ID (to identify in-application purchases), a virtual wallet ID (to identify wallet transactions), a terminal ID, etc. included in the transaction data for the transaction (e.g., in the authorization request for the transaction, etc.). Upon identification of the particular ID, the prediction engine 118 searches in the known application data structure for the ID. If the ID is found, the prediction engine 118 again assigns a known card-on-file application sub-score to the transaction, for example, of “1.” However, if the ID is not found, the prediction engine 118 assigns a known card-on-file application sub-score to the transaction, for example, of “0.” Again, with reference to the four transactions in Table 1, the prediction engine 118 assigns a known card-on-file application sub-score of “0” for transactions #1 and #4 because the Application ID is unknown. For transaction #2, the Application ID of 123123123 corresponds to a known virtual wallet application; and for transaction #3, the Application ID of 526795311 corresponds to an application known to offer in-application transactions. As such, the prediction engine 118 assigns a known card-on-file application sub-score of “1” to each of transactions #2 and #3. Like above, it should be appreciated that different scores (or values) may be used for known card-on-file application sub-score s in other method embodiments, to indicate knowledge of an application involved in a transaction as offering card-on-file transactions (and/or a probability of the same). For example, where an application provides for in-application transactions, but also non-in-application transactions, the prediction engine 118 may determine a known card-on-file application sub-score to account for the mixed transaction types (e.g., a 0.5 score, etc.).

At 310, the prediction engine 118 determines a known card-on-file merchant sub-score, which is based on the known merchant data structure of the data structure 120. As previously described, the known merchant data structure includes a listing of merchants that are known to accept card-on-file transactions (i.e., a listing of known card-on-file merchants). The prediction engine 118 identifies the merchant from the merchant name and/or the merchant ID included in the transaction data for the given transaction. Upon identification of the merchant, the prediction engine 118 searches in the known merchant data structure for the merchant. If the merchant is found, the prediction engine 118 assigns a known card-on-file merchant sub-score to the transaction, for example, of “1.” If the merchant is not found, however, the prediction engine 118 assigns a known card-on-file merchant sub-score to the transaction, for example, of “0.” With reference to the four transactions in Table 1, the merchant 102a is known to offer card-on-file transactions, while the merchant 102b is not (e.g., while transaction #3 includes a known card-one-file application ID, the merchant 102b may allow a “guest” check-out feature that doesn't use card-one-file functionality (as with transaction #4), hence the reason the merchant 102b may not be known to offer card-on-file transactions; etc.). As such, for each of transactions #1 and #2, the prediction engine 118 assigns a known card-on-file merchant sub-score of “1;” and for each of transactions #3 and #4, the prediction engine 118 assigns a known card-on-file merchant sub-score of “0.” Like above, it should be appreciated that different scores (or values) may be used for known card-on-file merchant sub-scores in other embodiments, to indicate knowledge that a merchant involved in a transaction offers/provides card-on-file transactions (and/or a probability of the same).

At 312, the prediction engine 118 determines a CVC presence sub-score, based on whether the transactions data for the transactions includes a CVC and based on data related to penetration of CVC indicators included in the data structure 120. As described, absence of CVC in transaction data for a transaction may indicate that the transaction involves a card-on-file transaction. However, this may vary between markets and essentially depends on the CVC penetration for the markets (i.e., the higher the CVC penetration in a given market, the more likely the absence of the CVC for a transaction in the market is a card-on-file transaction). As such, the CVC presence sub-score may vary (e.g., between 0.4 and 0.8, between other numerical values, etc.), based on the CVC penetration. With regard to the four transactions in Table 1, transaction #1 occurs in market 1; transaction #2 occurs in market 2; and transactions #3 and #4 occur in market 3. In connection therewith, market 1 has a 20% CVC penetration, market 2 has a 10% CVC penetration, and market 3 has a 90% CVC penetration. As such, the merchant 102a belongs to markets (i.e., markets 1 and 2 in this example) with a relatively low CVC penetration, while the merchant 102b belongs to a market (i.e., market 3) with a relatively high CVC penetration. As a result in this example, the CVC presence sub-score for transaction #1 is 0.0, because the transaction data actually includes the CVC. And, the CVC presence sub-score for transaction #2 is 0.4 (which is relatively low because of the low CVC penetration for market 2), and the CVC presence sub-score for each of transactions #3 and #4 is 0.75 (which is relatively high because of the high CVC penetration for market 3).

Finally in this example, at 314, the prediction engine determines a prior history sub-score, which is based on historical transaction data for the payment account to which the transaction is directed. In this embodiment, the prediction engine 118 assigns the prior history sub-score based on counts of transactions for the payment account, and involving a particular merchant (or merchants), falling within specific ranges. As such, the prior history sub-score may again vary (e.g., between 0.5 and 1, between other numerical values, etc.), based on the count. For example, the prediction engine 118 may assign a prior history sub-score of 0.5 to a transaction if the associated payment account includes less than four other transactions to the same merchant within the last year; a prior history sub-score of 0.7 to a transaction if the associated payment account includes four to six other transactions to the same merchant within the last year; a prior history sub-score of 0.9 to a transaction if the associated payment account includes seven to eleven other transactions to the same merchant within the last year; and a prior history sub-score of 1 to a transaction if the associated payment account includes twelve or more other transactions to the same merchant within the last year. With reference to Table 1, the consumer's payment account was used in the last year to fund eleven other transactions involving the merchant 102a and, as such, the prediction engine 118 determines a prior history sub-score of 0.9 for transactions #1 and #2. Likewise, the consumer's payment account was also used in the last year to fund four other transactions involving the merchant 102b and, as such, the prediction engine 118 determines a prior history sub-score of 0.5 for transactions #3 and #4. Again, it should be appreciated that other values (and/or ranges of values as illustrated herein) for prior history sub-score may be used in other embodiments.

With that said, it should be appreciated that, in this embodiment, the various sub-scores illustrated in FIG. 3 and described above can be determined in any particular order (or even at the same time). Nothing herein should be understood to limit the determination of the sub-scores to a particular order in this embodiment. In addition, because each sub-score is generally determined independent of one another, in this exemplary embodiment, it should be appreciated that the sub-scores may be determined, in parallel, for example, or in any other different order. In other embodiments, however, where dependencies may exist, a particular ordering of determining one or more of the sub-scores may be imposed. Further it should be appreciated that more, less or other sub-scores than illustrated in FIG. 3, indicative of card-on-file factors, may be included in the determination (at 304) of the sub-scores in other embodiments.

With continued reference to FIG. 3, once the desired sub-scores are determined (based on one or more desired card-one-file factors to be considered), the prediction engine 118 then calculates, at 316, a card-on-file probability score based on the determined sub-scores. In particular in this exemplary embodiment, when any of the recurring payment sub-score, the known card-on-file application sub-score, or the known card-on-file merchant sub-score is “1” for a transaction, then the card-on-file probability score for the transaction is “1.” Otherwise, the prediction engine 118 averages all of the determined sub-scores to calculate the card-on-file probability score. In connection therewith, Table 2 below includes each of the five sub-scores (as determined at 306-314 and as described above) for transactions #1-#4 from Table 1, along with the calculated card-on-file probability score for each of the transactions.

TABLE 2

| | Trans- | Trans- | Trans- | Trans- |
|---|---|---|---|---|
| | action #1 | action #2 | action #3 | action #4 |
| Recurring payment | 1 | 0 | 0 | 0 |
| sub-score | | | | |
| Known card-on-file | 0 | 1 | 1 | 0 |
| application sub-score | | | | |
| Known card-on-file | 1 | 1 | 0 | 0 |
| merchant sub-score | | | | |
| CVC presence sub-score | 0.0 | 0.4 | 0.75 | 0.75 |
| Prior history sub-score | 0.9 | 0.9 | 0.5 | 0.5 |
| Card-on-file | 1 | 1 | 1 | 0.25 |
| Probability Score | | | | |

It should be appreciated that the prediction engine 118 may impose other rules/guidelines and/or mathematical operations in other embodiments to calculate the card-on-file probability score (at 316). For example, and without limitation, the prediction engine 118 may average individual sub-scores (regardless of values of any of the particular sub-scores), sum individual sub-scores, multiple individual sub-scores, etc. Further, in various embodiments, the prediction engine 118 may weight individual sub-scores prior to performing such mathematical operations.

Then, once the card-on-file probability score is calculated for the transaction, the prediction engine 118 determines whether the score satisfies a defined threshold, at 318. The defined threshold may be imposed based on modeling the sub-scores (and their resulting combination) for known card-on-file transactions, based on empirical data, or otherwise. When the threshold is satisfied, the prediction engine 118 appends, at 320, a card-on-file label to the transaction, either in the transaction data associated with the transaction (or in a transaction message associated with the transaction) or otherwise for use by other entities. Alternatively, when the threshold is not satisfied, the prediction engine 118 optionally appends (as indicated by the dotted lines in FIG. 3), at 322, a “not” card-on-file label to transaction data associated with the transaction (or in a transaction message associated with the transaction). The label for not card-on-file may be appended to provide an indicator to one or more entities that the transaction was subject to the operation described herein yet not determined to be a card-on-file transaction.

In connection with the example transactions provided in Tables 1 and 2, the defined threshold for the card-on-file probability score (e.g., as calculated at 316 in the method 300, etc.), is 0.8, where satisfying the threshold includes equaling or exceeding the threshold and, conversely, not satisfying the threshold includes falling below the threshold. As such, based on the card-on-file probability scores calculated for the example transactions by the prediction engine 118 (Table 2), transactions #1-#3 are determined to be card-on-file transactions (as the card-on-file probability scores for transactions #1-#3 are greater than 0.8). Transaction #4, however, is determined to be a not card-on-file transaction (as the card-on-file probability score for transaction #4 is less than 0.8).

In view of the above, the systems and methods herein permit transactions to be evaluated for use in determining a likelihood of whether or not they are card-on-file transactions. Such information can then be used by various entities in connection with providing various services to consumers (or others, such as merchants, etc.) involved in the transactions, etc. In particular, for example, the card-on-file labels (and/or underlying card-on-file probability scores) may be communicated to issuers associated with payment accounts used in the transactions to further enhance their fraud models (in connection with authorizing the transactions), as card-on-file transactions are often perceived as more secure (since consumers typically have to login to merchants' websites to make such transactions, thereby providing an added layer of authentication to the consumers/transactions). In turn, the issuers may approve more transactions, when such card-on-file labels, for example, are present. As another example, as additional transactions identified as card-on-file transactions are approved by issuers (and are thereby identified as involving generally lower risk, as just discussed), merchants may be encouraged to adopt/promote card-on-file transactions with their consumers, whereby the merchants may receive lower merchant discount rates (MDRs) and lower interchange categories (thereby also creating a pipeline of merchants supporting card-on-file transactions).

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: (a) accessing transaction data included in a data structure, the transaction data including transaction data for a transaction associated with a payment account and involving a merchant; and (b) generating a card-on-file probability score for the transaction, based on at least two of the following factors: whether the transaction data includes a recurring payment indicator for the transaction, whether the transaction involves a known card-on-file application, whether the merchant is a known card-on-file merchant, whether a card verification code is included in the transaction data for the transaction, and whether other transactions to the payment account and involving the merchant have been made in a defined interval, whereby a card-on-file status of the transaction is true when the card-on-file probability score satisfies a defined threshold.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “connected to,” “coupled to,” or “in communication with” another feature, it may be directly on, connected or coupled to, or in communication with the other feature, or intervening features may be present. In contrast, when a feature is referred to as being “directly on,” “directly connected to,” “directly coupled to,” or “directly in communication with” another feature, there may be no intervening features present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in identifying card-on-file payment account transactions, the method comprising:
accessing, by a computing device, transaction data included in a data structure, the transaction data including transaction data for a transaction associated with a payment account and involving a merchant; and
generating, by the computing device, a card-on-file probability score for the transaction, based on at least two of the following factors: whether the transaction data includes a recurring payment indicator for the transaction, whether the transaction involves a known card-on-file application, whether the merchant is a known card-on-file merchant, whether a card verification code is included in the transaction data for the transaction, and whether other transactions to the payment account and involving the merchant have been made in a defined interval;
whereby a card-on-file status of the transaction is true when the card-on-file probability score satisfies a defined threshold.

2. The computer-implemented method of claim 1, further comprising comparing, by the computing device, the card-on-file probability score to the defined threshold, and appending a card-on-file tag to the transaction when the card-on-file probability score satisfies the defined threshold.

3. The computer-implemented method of claim 1, wherein generating the card-on-file probability score for the transaction includes calculating the card-on-file probability score from sub-scores associated with the at least two of the factors; and
wherein one of the sub-scores is based on the factor of whether the transaction data includes a recurring payment indicator for the transaction.

4. The computer-implemented method of claim 3, further comprising:
accessing, by the computing device, a card-on-file merchant data structure including multiple known card-on-file merchants;
assigning a first value to a second one of the sub-scores when the merchant is one of the multiple known card-on-file merchants; and
assigning a second different value to the second one of the sub-scores when the merchant is not one of the multiple known card-on-file merchants.

5. The computer-implemented method of claim 3, further comprising:
assigning a first value to a second one of the sub-scores, based on the known card-on-file application, when the transaction includes an in-application purchase; and
assigning a second different value to the second one of the sub-scores, based on the known card-on-file application, when the transaction does not includes the in-application purchase.

6. The computer-implemented method of claim 3, further comprising:
assigning a first value to a second one of the sub-scores, based on the known card-on-file application, when the transaction involves a known virtual wallet; and
assigning a second different value to the second one of the sub-scores, based on the known card-on-file application, when the transaction does not involve a known virtual wallet.

7. The computer-implemented method of claim 3, further comprising determining that the card-on-file probability score satisfies the defined threshold when the transaction data for the transaction includes a recurring payment indicator, when the transaction involves a known card-on-file application, and/or when the merchant is a known card-on-file merchant.

8. The computer-implemented method of claim 3, wherein calculating the card-on-file probability score from the sub-scores includes averaging the sub-scores.

9. The computer-implemented method of claim 1, wherein the card-on file probability score is based on sub-scores associated with each of: whether the transaction data includes a recurring payment indicator for the transaction, whether the transaction involves a known virtual wallet application, whether the merchant is a known card-on-file merchant, whether a card verification code is included in the transaction data for the transaction, and whether other transactions to the payment account and involving the merchant have been made in a defined interval.

10. A system for use in identifying card-on-file payment account transactions, the system comprising:
at least one memory comprising a card-in-file merchant data structure including a listing of known card-on-file merchants, a known application data structure including a listing of multiple applications associated with card-on-file transactions, a card verification code (CVC) data structure including CVC penetration data, and a transaction data structure including at least one transaction involving a merchant; and
a prediction engine coupled to the at least one memory and configured, for a transaction, to:
determine a first sub-score for the transaction, based on a first one of multiple card-on-file factors for the transaction, the card-on-file factors including: whether the transaction data includes a recurring payment indicator for the transaction, whether the transaction involves a known card-on-file application, whether the merchant is a known card-on-file merchant, whether a card verification code is included in the transaction data for the transaction, and whether other transactions to the payment account and involving the merchant have been made in a defined interval;
determine a second sub-score for the transaction based on a second one of the multiple card-on-file factors;
determine a third sub-score for the transaction based on a third one of the multiple card-on-file factors;
combine the first sub-score, the second sub-score, and the third sub-score into a card-on-file probability score; and
append at least one of the card-on-file probability score and a label associated with the card-on-file probability score to the at least one transaction, the label being associated with the card-on-file probability for the transaction relative to a defined threshold.

11. The system of claim 10, wherein the prediction engine is configured to access the transaction prior to determining the first sub-score.

12. The system of claim 10, wherein the prediction engine is configured to append the label associated with the card-on-file probability score to the transaction.

13. The system of claim 12, wherein the label associated with the card-on-file probability score is a card-on-file label; and
wherein the prediction engine is configured to determine that the card-on-file probability score satisfies the defined threshold and append the card-on-file label to the transaction when the transaction data for the transaction includes a recurring payment indicator, when the transaction involves a known card-on-file application, and/or when the merchant is a known card-on-file merchant.

14. The system of claim 10, wherein the prediction engine is further configured to determine a fourth sub-score based on a fourth one of the multiple card-on-file factors; and
wherein the prediction engine is configured to combine the first sub-score, the second sub-score, the third sub-score, and the fourth sub-score into the card-on-file probability score.

15. The system of claim 13, wherein the prediction engine is further configured to determine a fifth sub-score based on a fifth one of the multiple card-on-file factors; and
wherein the prediction engine is configured to combine the first sub-score, the second sub-score, the third sub-score, the fourth sub-score, and the fifth sub-score into the card-on-file probability score.

16. A non-transitory computer-readable storage media including computer-executable instructions for identifying a card-on-file status of a transaction that, when executed by a processor, cause the processor to:
access a transaction including a merchant identifier and a consumer identifier;
determine a plurality of card-on-file factors for the transaction, wherein the plurality of card-on-file factors includes at least two of a recurring payment factor, an in-app purchase factor, a card-on-file merchant factor based on the merchant identifier, an absent card verification code factor, and a habitual spending factor based on the consumer identifier; and
determine a card-on-file probability score based on the plurality of card-on-file factors.

17. The non-transitory computer-readable storage media of claim 16, wherein the executable instructions, when executed by the processor, further cause the processor to append a card-on-file label to the transaction when the card-in-file factors for the transaction includes a recurring payment factor, an in-app purchase factor, and/or a card-on-file merchant factor.

18. The non-transitory computer-readable storage media of claim 17, wherein the executable instructions, when executed by the processor, further cause the processor, when the card-in-file factors for the transaction do not include a recurring payment factor, an in-app purchase factor, and a card-on-file merchant factor, to:
compare the card-on-file probability score to a defined threshold; and
append a card-on-file label to the transaction when the card-on-file probability score satisfies the defined threshold.

19. The non-transitory computer-readable storage media of claim 18, wherein determining the card-on-file probability score includes averaging sub-scores for each of the plurality of card-on-file factors.

20. The non-transitory computer-readable storage media of claim 16, wherein the card-on file probability score is based on sub-scores associated with each of the recurring payment factor, the in-app purchase factor, the card-on-file merchant factor, the absent card verification code factor, and the habitual spending factor based on the consumer identifier.
